(19) United States
(12) Patent Application Publication
(10) Pub. No.: US 2016/0297099 A1
(43) Pub. Date: Oct. 13, 2016

(54) PORTABLE AGGREGATE MIXING SYSTEM

(71) Applicants: Scott E. McPherson, San Diego, CA (US); Robert Hulburd, San Diego, CA (US); Dennis Riley, Dearborn, MI (US)

(72) Inventors: Scott E. McPherson, San Diego, CA (US); Robert Hulburd, San Diego, CA (US); Dennis Riley, Dearborn, MI (US)

(21) Appl. No.: 15/015,016

(22) Filed: Feb. 3, 2016

Related U.S. Application Data
(60) Provisional application No. 62/111,197, filed on Feb. 3, 2015.

(51) Int. Cl. B28C 5/14; B01F 15/00; B01F 13/00

(52) U.S. Cl. CPC B28C 5/148; B01F 13/0032; B01F 15/0022; B01F 15/00246; B01F 15/00136; B01F 15/0024; B01F 2215/0047

(57) ABSTRACT

The present invention generally relates to mixing systems for concrete, mortar, grout or other aggregate and more specifically to portable single person carries mixing systems capable of mixing concrete or other aggregates uniformly, rapidly and with less waste. In accordance with one aspect of at least one embodiment of the present disclosure, a portable aggregate mixing system is disclosed comprising a mixer with a power source and mixing tines and a mixing container comprising sidewalls, a bottom surface, a front and back wall and an open top. The mixing system coordinates the mating of the mixing blades or tines of a mixer with the surface characteristics of a customized or standard mixing tub or wheelbarrow to ensure uniform mixing of aggregate occurs quickly with minimal waste.

### CROSS-REFERENCE TO RELATED PATENT APPLICATIONS

Embodiments of the present invention relate to U.S. Provisional Application Ser. No. 62/111,197, filed Feb. 3, 2015, entitled “Portable Aggregate Mixing System”, the contents of which are incorporated by reference herein in its entirety and which is a basis for a claim of priority

### FIELD OF THE INVENTION

The invention generally relates to mixing systems for concrete, mortar, grout or other aggregate and more specifically to a portable single person carry mixing system capable of mixing concrete or other aggregates uniformly, rapidly and with less waste.

### BACKGROUND OF THE INVENTION

The use of concrete, mortar, grout and other aggregates is pervasive in the construction industry for creating a stable foundation or setting for other materials (such as tile) or bricks for walls when mixed properly. However improperly mixed aggregates, such as concrete, mortar and grout, are fragile and can be a tremendous safety hazard resulting in the destruction of property or even serious injury or loss of life.

Presently the main options in the field are hand mixing with hoe and wheelbarrow which typically yields highly variable mixing based on the skill and patience of the worker providing the manual labor, or for mixing materials in a more uniform way drum mixers are typically used. The problem however with the drum mixers is that they are typically large and very heavy, usually hundreds of pounds, and therefore are not very portable for a general user. Although recently, some smaller versions of drum mixers have entered the marketplace, they are still at least in excess of one hundred pounds and have poor commercial durability. Additionally, they are very difficult to clean because of the internal mixing arm, and the closed nature of the drum. Because material sticks in various parts of the drum it is laborious to clean and requires more time and water.

Water used to clean concrete mixing equipment is regulated as a pollutant because it is caustic and thus is not allowed in storm drains. Thus, cleaning in compliance with the environmental laws often requires the user to place any water used to clean the equipment in evaporation pans which adds another burden to the user.

Additionally, a major problem with mixing aggregates is the ability to determine that the mix has been mixed thoroughly and uniformly throughout the batch, and when mixes multiple batches whether each batch is consistent with the others.

Unfortunately, a robust and easy to use portable concrete mixing system has not previously been described. Thus a need exists for a mixing system that efficiently mixes product thoroughly and is easy to clean and can be adaptable to multiple mixing situations.

Further, the portable mixers found in of the prior art have not been commercialized because of their shortcomings related to the destruction of mixing containers, or not having the ability to create a uniform mixing of the material because the mixing tines do not come into contact with all of the material.

As such, one reason why drum mixers are still widely used is that the drum mixers roll the mix for long periods of time such that eventually the mix gets mixed thoroughly. The previous tub-type mixers were not able to fully integrate into a system where uniform mixing would occur because they were not adapted to be integrated with a specialized tub mating system. The portable concrete mixers in prior art were never commercialized because the mixers destroyed the tubs, had tine breakdown because of either poor design or lack of coordination of elements, and were unable to create uniform mixes because the variability of the interaction with the mixers to non-optimized and/or standard tubs was too high to overcome.

The present embodied invention meets this need and is described further below.

### SUMMARY OF THE INVENTION

The present invention relates to a mixing system for aggregate materials, and more specifically to a specialized mixing system that is highly portable, highly adaptable, fast and efficient which enables the user to mix batches of aggregate quickly in 5 minutes or less, in a very uniform way, based on an integration of mixing blades and containment tubs which feed the material into the path of the mixing blades. Although the mixing times and volumes may vary, a preferred mixing capacity for an embodied mixing system is 5-150 pounds of mix (before water is added) which can be mixed thoroughly in 60-180 seconds by a typical user. With a preferred maximum per mix threshold capacity of about 120 pounds, and a preferred minimum per mix threshold capacity of about 5-10 pounds of mix. Another preferred embodiment of the system is that 100 pounds of mix can be uniformly mixed in less than 100 seconds.

In accordance with one aspect of at least one embodiment of the present disclosure, a portable aggregate mixing system is disclosed comprising: 1) a mixer with a power source and mixing tines: 2) a mixing container comprising sidewalk, a bottom surface, a front and back wall and an open top; 3) wherein the mixer is mated to the mixing container by matching at least two of the four listed tub tine interaction points; a) a tub/tine integration surface wherein the bottom of the sidewalls of the tub and the contact portion of the mixing tine have a similar surface angle X; b) a tub/tine integration surface wherein the front and back walls of the containment tub have a similar angle of interface Y as that of the curvature and diameter of the tub contact tine; c) a tub/tine integration surface comprises a tine system which integrates with a specific width of the tub at a distance W that is short enough to allow for the continuous mixing of the material on both sides of the tine system; and d) a tub/tine integration surface wherein the tub contacts the tine angles in a way that matches the sloping Z of the sidewalls of the containment tub.

Additionally the mixing system is easy to clean and serves as a greener solution to the alternative systems for mixing aggregate material. The embodiments of the present invention typically mix the materials so well that there is very little waste left on the sides of the containment tub, and the open unobstructed tub and mixing tines are easily cleaned with minimal time, effort and water. A preferred time for cleanup of the system is less than 5 minutes, with a more preferred time frame of 2-3 minutes to rinse the tines and tubs clean enough to be stored for future use, without a loss of system performance.

Embodiments of the present invention relate to a mixing system for mixing batches of concrete mortar or grout in a uniform, rapid and efficient way that enables users of all skill levels to understand and use the mixing system in a safe and effective way. Furthermore the system is designed to reduce system component breakdowns by reducing the interaction of moving parts with the containers.

Because a lack of uniformity of mix is dangerous, the present invention relates to a mixing system capable of creating a quick and uniform mixing system, which can easily adapt to the size or conditions of the job to be performed. Additional sensing components can be placed at strategic points on or near the mixing tines, gear box, mixing tub, and or drag bar. Embodiments include sensors with the ability to measure moisture content, as content or percent of various mix components such as 25-40% Portland cement in a mix, or the percentage of silica in a mix or various other mineral components.

Embodiments with electric motors and/or battery pack powered motors can be used indoors at point of pour without dangerous fume issues associated with gas motors, whereas robust gas models may be used in outdoor areas where access to electricity to charge battery packs or power the motor is limited.

Additional embodiments allow for the use of multiple tubs to expand the project to a much larger volume of mixed material while maintaining the same mixer and tubs. Because each tub is mixed thoroughly and quickly, it is possible to mix many tubs in a bucket brigade manner to adapt to a bigger job requiring more mix. In contrast, the drum mixers prevalent in the art, typically have a set drum volume and take quite a bit of time to achieve thorough mixing. Additionally, if the mix is a little short for the job another batch must be made in the big drum. Therefore, contractors typically make an excess amount of mix over their calculated batch to ensure there is plenty of material for the job, this results in much more waste, cost of materials, and a much longer clean-up time.

Embodiments of the present invention relate to a coordinated mixing system to mate an appropriate mixer design with an appropriate mixing tub such that the system can efficiently and thoroughly mix an aggregate while minimizing breakdown of either the tubs or the mixing blades or tines.

These and other features, aspects and advantages of the present invention will become better understood with reference to the following drawings, description and claims.

### BRIEF DESCRIPTION OF THE DRAWINGS

The principles of the present invention will be apparent with reference to the following drawings, in which like reference numerals denote like components:

FIG. A is a schematic diagram showing different tub/tine interactions associated with the mixing system according to an exemplary embodiment of the present invention.

FIG. 1B is a schematic diagram showing different tub/tine interactions associated with the mixing system according to an exemplary embodiment of the present invention.

FIG. 1C is a schematic diagram showing different tub/tine interactions associated with the mixing system according to an exemplary embodiment of the present invention.

FIG. 1D is a schematic diagram showing different tub/tine interactions associated with the mixing system according to an exemplary embodiment of the present invention.

FIG. 2 is a schematic diagram showing the relation of the tines with one another and with the sidewalls of the mixing system according to an exemplary embodiment of the present invention.

FIG. 3 is a schematic diagram showing the relation of the tines with one another and with the sidewalls of an embodied sloping tub and tine configuration according to an exemplary embodiment of the present invention.

FIG. 4A is a schematic diagram showing the system in various stages of use according to an exemplary embodiment of the present invention.

FIG. 4B is a schematic diagram showing the system in various stages of use according to an exemplary embodiment of the present invention.

FIG. 4C is a schematic diagram showing the system in various stages of use according to an exemplary embodiment of the present invention.

FIG. 5 is a schematic diagram showing an embodied tine design that has an X1 curvature which mates with the X2 curvature of the tub according to an exemplary embodiment of the present invention.

FIG. 6 is a schematic diagram showing an embodied tub with front and back end curvatures Y visible according to an exemplary embodiment of the present invention.

### DETAILED DESCRIPTION OF THE INVENTION

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

Although the present invention has been described with respect to a specific preferred embodiment thereof, various changes and modifications may be suggested to one skilled in the art and it is intended that the present invention encompass such changes and modifications as fall within the scope of the appended claims.

Broadly, embodiments of the present invention generally provide mixing systems for concrete, mortar, grout or other aggregate and more specifically to a portable single person carry mixing system capable of mixing concrete or other aggregates uniformly, rapidly and with less waste. More specifically, the present invention relates to a specialized mixing system that is highly portable, highly adaptable, fast and efficient which enables the user to mix batches of aggregate quickly in 5 minutes or less, in a very uniform way, based on an integration of mixing blades and containment tubs which feed the material into the path of the mixing blades. Although the mixing times and volumes may vary, a preferred mixing is 80-120 pounds of mix can be mixed thoroughly in 60-180 seconds by a typical user.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In accordance with one embodiment of the present invention, a portable aggregate mixing system is disclosed. The mixing system comprises: a mixer with a power source and mixing tines; a mixing container comprising sidewalls, a bottom surface, a front and back wall and an open top: wherein the mixer is mated to the mixing container by matching at least two of the four listed tub tine interaction points; a) a tub/tine integration surface wherein the bottom of the sidewalls of the tub and the contact portion of the mixing tine have a similar surface angle X; b) a tub/tine integration surface wherein the front and back walls of the containment tub have a similar angle of interface Y as that of the curvature and diameter of the tub contact tine; c) a tub/tine integration surface comprises a tine system which integrates with a specific width of the tub at a distance W that is short enough to allow for the continuous mixing of the material on both sides of the tine system: and d) a tub/tine integration surface wherein the tub contacts the tine angles in a way that matches the sloping Z of the sidewalls of the containment tub.

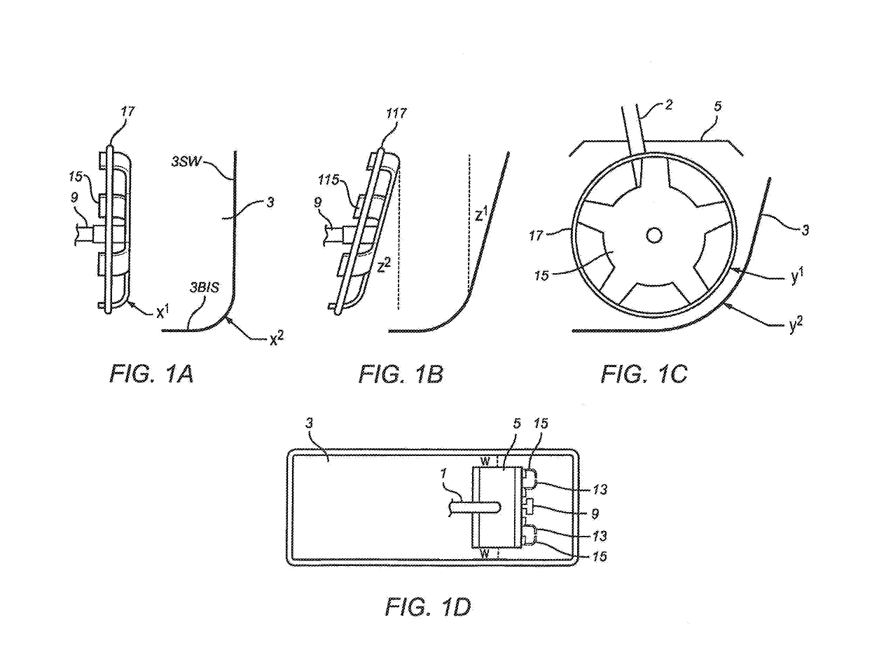

FIG. 1 comprises FIGS. 1A-1D, each represents different tub/tine interactions associated with an embodied mixing system. FIG. 1A illustrates the relationship of an embodied outer tine design in relation to the side's representation of the mating of an embodied outer mixing tine 15 with a tine interface curvature of X1 mating with a side wall 3SW of a mixing tub 3 with a tub interface curvature of X2. FIG. 1B of the mating of another embodied outer mixing tine 117 that has a slope 72 which matches the sloping Z1 of the sidewalls 3SW of an embodied mixing container. FIG. 1C is a visual representation of the mating of the external curvature of the mixing system Y1 wherein the curvature Y1 of the ring 17 on the outer tine 15 is mated with the tub tine integration point Y2 located on the front and back walls of the containment tub 3. FIG. 1D is a visual representation of how an embodied tine system integrates with a specific width of the tub at a distance W that is narrow enough to allow for the continuous mixing of the material on both sides of the tine system. Comprising inner tine 13 outer tine 15 and shroud cover 5. Additionally, there is a drag bar which provides structural support and stability and helps push material into the inner 13 and outer tines. Embodiments of the present invention integrate at least two to the tine/tub interaction points to assist with a thorough mixing of aggregate.

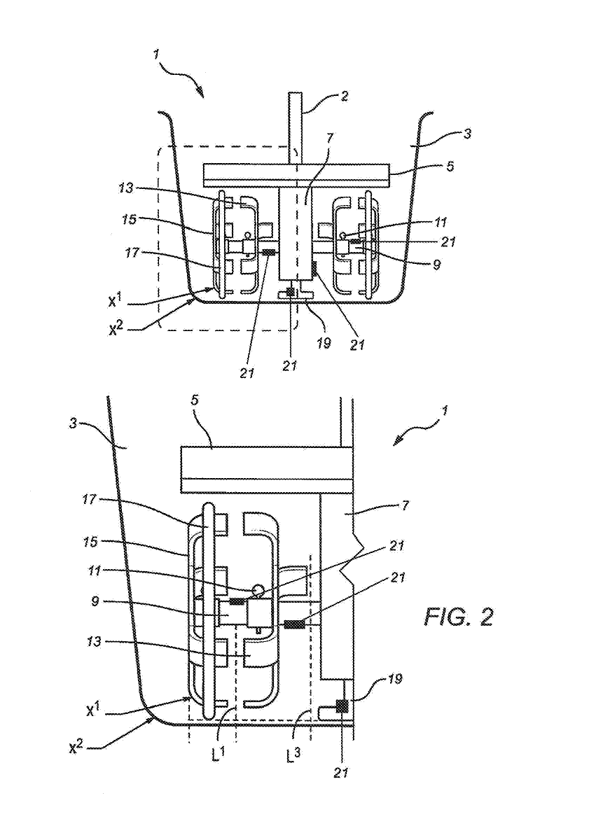

FIG. 2 comprises an embodied mixing system which shows the relation of the tines with one another and with the sidewalls of an embodied mixing tub 3. FIG. 2 includes an exploded view of the relationship of the curvature of X1 associated with the contact tine and X2 associated with the sidewall of the mixing tub 3. Also visible is the relationship of the contact tine with the inner tine 13 and the drag bar 19 is shown near the gear box. FIG. 2 also shows the addition of sensor(s) 21 and/or detector(s) placed at strategic places on the tines axle, gear box, or drag bar.

The blown up view of FIG. 2 demonstrates the placement of the outer tine ring 17 on the outer tine 15 and that the length L1 from the axel 9 is equal to the length L3 of the drag bar 19 location. By having L1 and L3 similar lengths the relationship of the tine ring 17 and drag bar 19 enhance stability of the system. The blown up view shows a sensor 21 placed on the axle between the inner and outer tines and on the axle between the gear box and inner tine and on the drag bar.

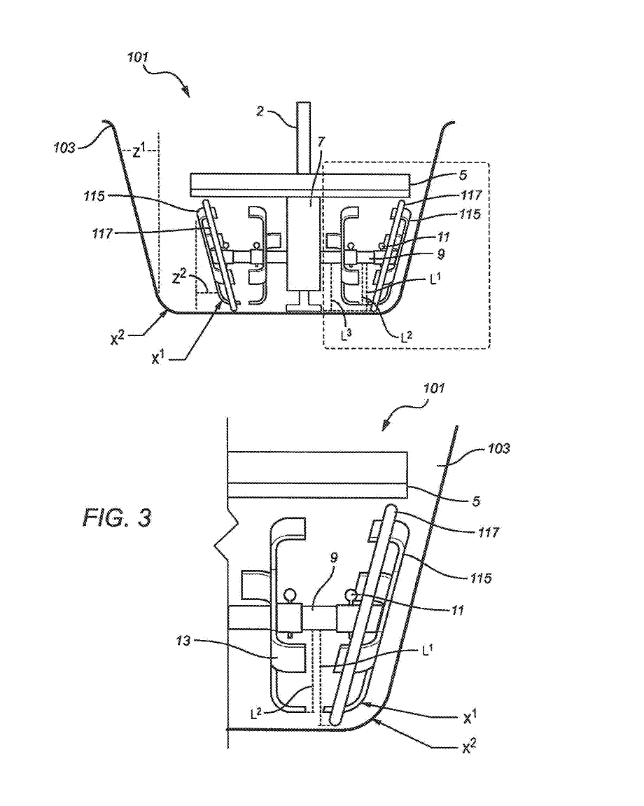

FIG. 3 comprises another embodied mixing system which shows the relation of the tines with one another and with the sidewalls of an embodied sloping tub and tine configuration. FIG. 3 includes an exploded view of a tine slope integration. The mixer 2 comprises gear box 7 a shroud 5, and a slope Z2 of the outer tine 115 and attached ring 117 wherein the tine slope Z2 mimics the slope Z1 of the outer wall of an embodied tub 3. The tines are held in place on the axel 9 with pins 11. The relationship of the length of the inner tine 13 is shown wherein the length L2 of the tine from the axel 9 is shorter for the than the length L1 of the outer ring 117 of the outer tine. This embodiment matches the outer tine curvature x1 with the curvature x2 of the outer tub and the slope Z1 and Z2.

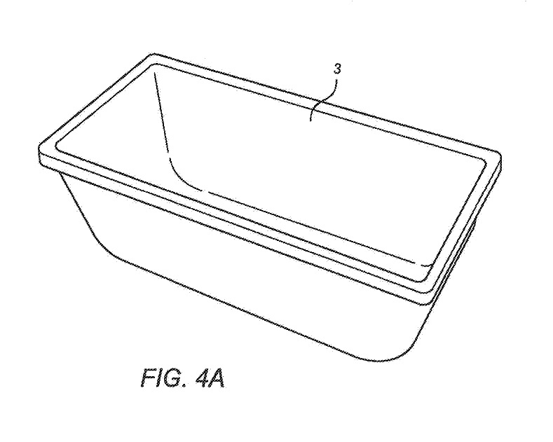

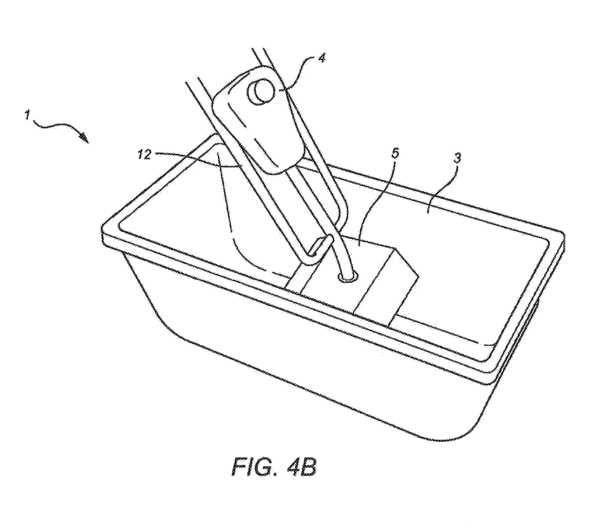

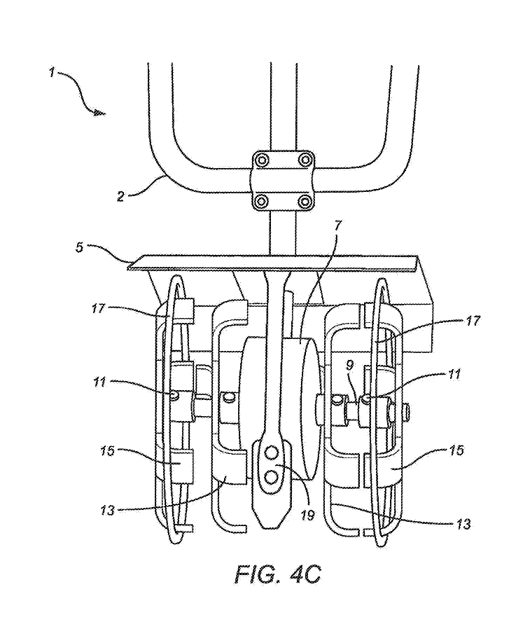

FIG. 4 comprises FIGS. 4A-4C which are schematic diagrams showing a mixing system in various stages of use. FIG. 4A shows an empty embodied containment tub 3 before adding the aggregate. FIG. 4B shows a mixing system 1 in use while mixing aggregate. The shroud 5 protects the user from material flying up and the frame 12 supports the mixer unit while the power source 4 propels the tines. FIG. 4C shows the relationship of the outer tines 15 with the inner tines 13 wherein very little space is left between the blades of the inner 13 and outer tines thus preventing material from not being exposed to the blades.

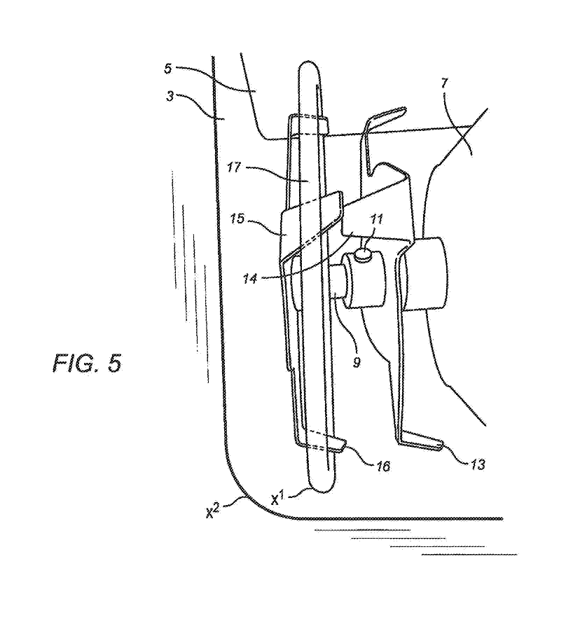

FIG. 5 demonstrates how the outward blade 14 of the inner tine 13 barely clears the inner blade 16 of the outer tine 15 of an embodied tine design that has an X1 curvature which mates with the X2 curvature of the tub.

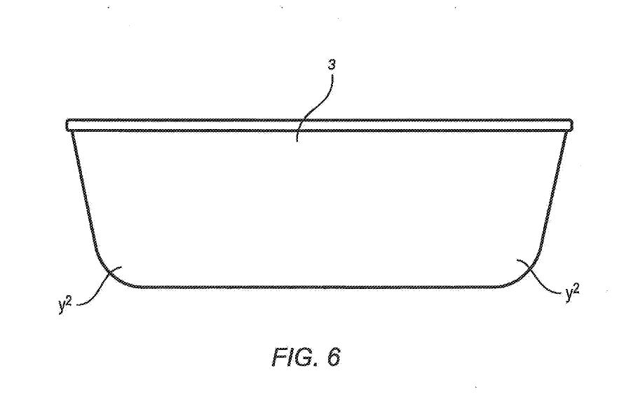

FIG. 6 shows an embodied tub with front and back end curvatures Y2 visible which are mated with the curvature Y1 of the outer tine ring 17.

In one embodiment of the present invention, the mixing system overcomes the inadequacies of prior art by coordinating the mixer and tine interface with tub container properties so that a successful and uniform mixing of material can be assured, without causing excess wear to the mixing tub or tine interface.

In yet another embodiment of the present invention, the mixing system ensures proper mixing by including detecting mean(s) and/or batch control data keeping for quality control and safety issues. Embodied detecting and sensing means help determine and communicate proper mixing and/or proper ratios of mixing components as well as the proper aeration of various requirements for mixed aggregate.

In yet another embodiment of the present invention, the use of multiple tubs is allowed to expand the project to a much larger volume of mixed material while maintaining the same mixer and tubs. Because each tub is mixed thoroughly and quickly, it is possible to mix many tubs in a bucket brigade manner to adapt to a bigger job requiring more mix. In contrast, the drum mixers prevalent in the prior art typically have a set drum volume and take quite a bit of time to achieve thorough mixing. Additionally, if the mix is a little short for the job another batch must be made in the big drum. Therefore, contractors typically make an excess amount of mix over their calculated batch to ensure there is plenty of material for the job, this results in much more waste, cost of materials, and a much longer clean-up time.

In yet another embodiment of the present invention, the mixing system utilizes at least two or more tub/tine integration faces to allow for the rapid and uniform mixing of all of the material within a mated containment tub.

For example and not by way of limitation, a first embodied tub/tine integration surface is the bottom of the sidewalls of the tub and the contact portion of the mixing tine has a similar surface angle X. A second embodied tub/tine integration surface is the front and back walls of the containment tub have a similar angle of interface Y as that of the curvature and diameter of the tub contact tine. A third embodied tub/tine integration surface is the tine system integrates with a specific width of the tub at a distance W that is short enough to allow for the continuous mixing of the material on both sides of the tine system. A fourth embodied tub/tine integration surface is the tub contact tine angles in a way that matches the sloping Z of the sidewalls of the containment tub.

In yet another embodiment of the present invention, the mixing system further comprises a track system within the tub which maintains tine distance from the surface of the tub while allowing mixing of material.

In yet another embodiment of the present invention, a shorter handled unit with tines is interchangeable to match an existing mixing container such as a wheelbarrow, or standard sized mixing, tubs.

In yet another embodiment of the present invention, the mixing system uses sensor(s) 21 and/or strategic detector(s) to transmit data related to the proper mixing of the material to the user or to a database which can be used for storage of data for at least quality control purposes. For example and not by way of limitation, for some Quikrete® type products the recommended mixture is one part water for every 5 parts mix. Thus a set of parameters can be set so that until the mix is tested and a set number of readings at one or more sensors 21 are reached a signal will tell the user to keep mixing until proper mix is achieved.

In yet another embodiment of the present invention, the mixing system includes sensor(s) 21 and/or detector(s) that may be wired or wireless and communicate with an interface on the mixer or on a user's personal electronic device. The sensors) 21 may also send information to a digital interface wherein each batch data can be recorded. In addition, by using one or more detector(s) and/or sensor(s) 21 the system can ensure uniform mixture of the mix and or the proper ratios of mixing elements such as Portland cement, sand and gravel. Other detectors may also be used utilized to perform gas measurements such as the ideal oxygen or nitrogen or various other mixing gases indicative of a properly mixed aggregate. The detector(s) may also be used to test viscosity of fluid, aeration, flow speed of material, and moisture detection.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A portable aggregate mixing system comprising:
a mixer with a power source and mixing tines;
a mixing container comprising sidewalls, a bottom surface, a front and back wall and an open top;
wherein the mixer is mated to the mixing container by matching at least two of the four listed tub tine interaction points;
a) a tub/tine integration surface wherein the bottom of the sidewalls of the tub and the contact portion of the mixing tine have a similar surface angle X;
b) a tub/tine integration surface wherein the front and back walls of the containment tub have a similar angle of interface Y as that of the curvature and diameter of the tub contact tine;
c) a tub/tine integration surface comprises a tine system which integrates with a specific width of the tub at a distance W that is short enough to allow for the continuous mixing of the material on both sides of the tine system; and
d) a tub/tine integration surface wherein the tub contacts the tine angles in a way that matches the sloping Z of the sidewalls of the containment tub. The portable aggregate mixing system of claim 1, wherein the tine tub interface is adjustable in the field through the use of a plurality of tine design that are easily interchanged and configured to the mixing container parameters.

3. The portable aggregate mixing system of claim 1, wherein the mixer is configured to coordinate with an interface of the tine to ensure successful and uniform mixing of materials.

4. The portable aggregate mixing system of claim 1, wherein the mixers comprises a detecting mean for maintaining quality control and safety issues of the mixing system.

5. The portable aggregate mixing system of claim 4, wherein the detecting mean determines and communicates proper mixing or proper ratios of mixing components as well as the proper aeration of various requirements for mixed aggregate.

6. The portable aggregate mixing system of claim 1, further comprises a track system within the tub which maintains tine distance from the surface of the tub while allowing mixing of material.

7. The portable aggregate mixing system of claim 1, tines are interchangeable to match existing mixing containers.

8. The portable aggregate mixing system of claim 1, further comprises at least one sensor or detector to transmit data related to proper mixing of material to a user or to a database which can be used for storage of data for at least quality control purposes.

9. The portable aggregate mixing system of claim 8, wherein the at least one sensor or detector is wired or wireless and communicates with an interface on the mixer or on a user's personal electronic device.

10. The portable aggregate mixing system of claim 8, wherein the sensor sends information to a digital interface where each batch data can be recorded.

11. The portable aggregate mixing system of claim 8, wherein the detector measures oxygen, nitrogen or various other mixing gases indicative of a properly mixed aggregate.

12. The portable aggregate mixing system of claim 8, wherein the detector measures viscosity of fluid, aeration, flow speed of material, and moisture detection.

13. A portable aggregate mixing system comprising:
a mixer with a power source and mixing tines;
a mixing container comprising sidewalls, a bottom surface, a front and back wall and an open top; and
wherein the mixer is mated to the mixing container by matching a) a tub/tine integration surface wherein the bottom of the sidewalls of the tub and the contact portion of the mixing tine have a similar surface angle X; and b) a tub/tine integration surface wherein the front and back walls of the containment tub have a similar angle of interface Y as that of the curvature and diameter of the tub contact tine.

14. The portable aggregate mixing system of claim 13, wherein the mixer is mated to the mixing container by matching c) a tub/tine integration surface comprises a tine system which integrates with a specific width of the tub at a distance W that is short enough to allow for the continuous mixing of the material on both sides of the tine system.

15. The portable aggregate mixing system of claim 13, wherein the mixer is mated to the mixing container by matching d) a tub/tine integration surface wherein the tub contacts the tine angles in a way that matches the sloping Z of the sidewalls of the containment tub.

16. A portable aggregate mixing system comprising:
a mixer with a power source and mixing tines;
a mixing container comprising sidewalls, a bottom surface, a front and back wall and an open top;
wherein the mixer is mated to the mixing container by matching a) a tub/tine integration surface wherein the bottom of the sidewalls of the tub and the contact portion of the mixing tine have a similar surface angle X; b) a tub/tine integration surface wherein the front and back walls of the containment tub have a similar angle of interface Y as that of the curvature and diameter of the tub contact tine; c) a tub/tine integration surface comprises a tine system which integrates with a specific width of the tub at a distance W that is short enough to allow for the continuous mixing of the material on both sides of the tine system; and d) a tub/tine integration surface wherein the tub contacts the tine angles in a way that matches the sloping Z of the sidewalls of the containment tub.

17. The portable aggregate mixing system of claim 16, further comprises at least one sensor or detector to transmit data related to proper mixing of material to a user or to a database which can be used for storage of data for at least quality control purposes.

18. The portable aggregate mixing system of claim 17, wherein the at least one sensor or detector is wired or wireless and communicates with an interface on the mixer or on a user's personal electronic device.

19. The portable aggregate mixing system of claim 16, wherein the at least one sensor or detector measures oxygen, nitrogen or various other mixing gases indicative of a properly mixed aggregate.

20. The portable aggregate mixing system of claim 16, wherein the at least one sensor or detector measures viscosity of fluid, aeration, flow speed of material, and moisture detection.
